(19) United States
(12) Patent Application Publication
(10) Pub. No.: US 2013/0246905 A1
(43) Pub. Date: Sep. 19, 2013

(54) INFORMATION GENERATOR, INFORMATION OUTPUT DEVICE, AND RECORDING MEDIUM

(71) Applicant: KABUSHIKI KAISHA TOSHIBA, Tokyo (JP)

(72) Inventor: Hiroshi Isozaki, Kanagawa-ken (JP)

(73) Assignee: KABUSHIKI KAISHA TOSHIBA, Tokyo (JP)

(21) Appl. No.: 13/752,472

(22) Filed: Jan. 29, 2013

(30) Foreign Application Priority Data
Mar. 19, 2012 (JP) 2012-62548

(51) Int. Cl. G06F 17/22

(52) U.S. Cl. CPC G06F 17/2247
USPC 715/234

(57) ABSTRACT

An information generator has a first interface unit, a second interface unit, an application executing unit, a connection management unit to transmit the video data to the information output device through the second interface unit, a first screen output unit to display, on a display device, a list of web applications capable of being executed by the application executing unit, an application selector, a launcher, and a second screen output unit to display, on the display device, information for operating the information output device when the application executing unit accesses a URL notified by the launcher to acquire and execute the web application, and then the video data is transmitted to the information output device through the second interface unit.

### CROSS REFERENCE TO RELATED APPLICATIONS

This application is based upon and claims the benefit of priority from the prior Japanese Patent Application No. 2012-62548, filed on Mar. 19, 2012, the entire contents of which are incorporated herein by reference.

### FIELD

Embodiments of the present embodiment relate to an information generator and an information output device each capable of acquiring and displaying a web application.

### BACKGROUND

A mobile device such as a tablet and a smartphone widely used in recent years has a function of establishing a connection with the Internet through a wireless LAN or a 3G network. Most of such mobile devices have a Web browser, and the user can easily input characters, operate the device, and access a link (hyperlink) embedded in a Web page, by using an input device such as a touchpad.

Further, it is possible to arbitrarily customize the device and add various functions to the device by downloading applications from the Internet.

However, there is a problem that such a mobile device is not suitable for a situation where many people view the same screen since its screen size is extremely smaller than that of existing digital TVs.

On the other hand, the digital TV is excellent in that a high-definition moving image such as digital broadcasting can be playbacked in a large screen. However, the remote controller for operating the digital TV is not suitable to select one from many options as in the case of selecting a specific image or a moving image from a thumbnail list or clicking a link embedded in a Web page, which is because the remote controller provided originally to select the channel of a broadcast program or to adjust a volume level lacks a function of pointing an arbitrary location on the screen like a mouse for PC (personal computer) does.

The original object of the digital TV is to let users view broadcast programs. Generally, the transmission system and moving image format for broadcasting is determined by laws and standards in order to ensure the compatibility between digital TVs. Further, the standard specifying the broadcasting format is not frequently changed, and hardware such as a decoder is generally implemented in view of cost.

On the Internet, there is a video distribution service to provide data of moving images shot by users and premium content such as movies. Since each moving image has a video format selected by its service provider, various kinds of video formats and parameters are used. Accordingly, the video format employed in broadcasting is not always used on the Internet. Therefore, a great cost is required to make a digital TV capable of playbacking moving images while supporting various moving image formats on the Internet.

The tablet/smartphone, which is designed to be connected to the Internet, has a processing unit more sophisticated than the digital TV to playback various moving images on the Internet by executing decoder function implemented as a software or by having a decoder supporting various video formats. If the tablet/smartphone can decode moving image content acquired from the Internet and output it to the digital TV, the user can enjoy the moving image content on the large screen of the digital TV.

### BRIEF DESCRIPTION OF THE DRAWINGS

FIG. 1 is a diagram showing a schematic configuration of an information processing system 3 according to a first embodiment.

FIG. 2 is a block diagram showing the internal structure of an information generator 1 and an information output device 2.

FIG. 3 is a block diagram showing an example of the internal structure of an application executing unit 23 in the information generator 1.

FIG. 4A is a diagram showing a first display example of a web application list to be displayed on the screen of a screen output unit 28.

FIG. 4B is a diagram showing a second display example of a web application list to be displayed on the screen of the screen output unit 28.

FIG. 4C is a diagram showing a third display example of a web application list to be displayed on the screen of the screen output unit 28.

FIG. 5A is a diagram showing a first combination example of the information output device 2 and the information generator 1.

FIG. 5B is a diagram showing a second combination example of the information output device 2 and the information generator 1.

FIG. 5C is a diagram showing a third combination example of the information output device 2 and the information generator 1.

FIG. 6 is a diagram showing an example of a screen of web applications displayed on the information generator 1.

FIG. 7 is a sequence diagram showing processing steps according to the first embodiment.

FIG. 8 is a diagram showing a screen example for a moving image playback controller.

FIG. 9 is a block diagram showing an example of arranging a dongle device 6.

FIG. 10 is a block diagram showing the internal structure of the information output device 2 according to a second embodiment.

FIG. 11 is a block diagram showing the internal structure of an application executing unit 41 in the information output device 2.

FIG. 12 is a sequence diagram showing processing steps according to the second embodiment.

FIG. 13 is a sequence diagram following FIG. 12.

FIG. 14 is a block diagram showing the internal structure of the information generator 1 having an application distributing unit.

FIG. 15 is a sequence diagram corresponding to FIG. 14.

FIG. 16 is a block diagram showing the internal structure of the information output device 2 according to a third embodiment.

FIG. 17 is a sequence diagram showing processing steps according to the third embodiment.

FIG. 18 is a sequence diagram following FIG. 17.

FIG. 19 is a diagram showing an example of a screen generated by a screen output unit 17.

FIG. 20 is a diagram showing a screen display example of the information output device 2.

FIG. 21 is a block diagram showing the internal structure of the information output device 2 for realizing the screen display of FIG. 20.

FIG. 22 is a diagram showing processing steps for simultaneously displaying broadcast content and video content on the same screen.

FIG. 23 is a sequence diagram following FIG. 22.

### DETAILED DESCRIPTION

According to one embodiment, an information generator has a first interface unit to transmit a machine operating command for operating an information output device through a WebSocket connection, a second interface unit to transmit, to the information output device, video data capable of being playbacked by the information output device, an application executing unit to execute a web application for establishing the WebSocket connection and transmitting the machine operating command to the information output device, a connection management unit to transmit the video data to the information output device through the second interface unit, when it is confirmed that a connection for transmitting the machine operating command through the first interface unit and a connection for transmitting the video data through the second interface unit have been established with the same information output device based on a request from the web application, a first screen output unit to display, on a display device, a list of web applications capable of being executed by the application executing unit, an application selector to select a specific web application from the web application list displayed by the first screen output unit, a launcher to notify the application executing unit about a URL providing the web application selected by the application selector, and a second screen output unit to display, on the display device, information for operating the information output device when the application executing unit accesses a URL notified by the launcher to acquire and execute the web application, and then the video data is transmitted to the information output device through the second interface unit.

Embodiments will now be explained with reference to the accompanying drawings.

### First Embodiment

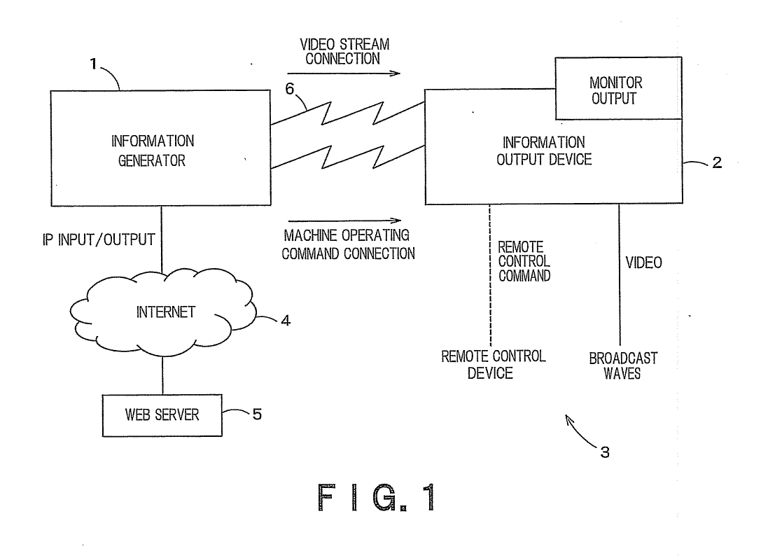

FIG. 1 is a diagram showing a schematic configuration of an information processing system 3 having an information generator 1 and an information output device 2 according to a first embodiment. The information processing system 3 of FIG. 1 has the information output device 2 capable of outputting AV data and text information included in broadcast waves, the information generator 1 capable of playbacking video content provided on an Internet 4, and a web server 5.

The information output device 2 and the information generator 1 are connected through a network 6, and the information generator 1 transmits, to the information output device 2, video content and a machine operating command for the information output device 2.

As a physical/link layer for transmitting the machine operating command from the information generator 1 to the information output device 2, it is possible to employ various communication configurations such as infrared rays, wireless LAN based on IEEE standard 802.11, Ethernet (registered trademark), etc. As a physical/link layer for transmitting moving image content from the information generator 1 to the information output device 2, it is possible to use an interface such as HDMI (High-Definition Multimedia Interface) (registered trademark), WirelessHD, WHDI, etc. to transmit an uncompressed video. Otherwise, it is possible to use an interface such as wireless LAN, Ethernet, HDMI-HEC (HDMI Ethernet Channel), WiFi Display, WiDi, etc. to transmit a compressed video encoded by the information generator 1 and decode the compressed video by the information output device 2.

Note that it does not matter whether such an interface is wired or wireless. When using the Internet Protocol (IP) as a network layer, it may be IPv4 or may be IPv6. Certainly, when using the IP as an interface, a wireless access point, a router, etc. (not shown) may be connected between the information output device 2 and the information generator 1. Here, explanation will be given on an example where a wireless LAN is used when transmitting a machine operating command from the information generator 1 to the information output device 2, while WiFi Display is used when transmitting a video stream from the information generator 1 to the information output device 2.

Here, the machine operating command includes, e.g., a command for controlling a tuner provided in the information output device 2 (e.g., for selecting a channel of the tuner) and a command for adjusting the volume level. When the information output device 2 can record and store broadcast content, the machine operating command further includes, e.g., a command for displaying a recorded content list, a command for playbacking specified recorded content, and a command for deleting specified recorded content. Further, the video stream transmitted from the information generator 1 to the information output device 2 has a format determined based on the transmission system of the physical layer or link layer. The format of the video stream will be mentioned in detail later.

In addition to the connection for communicating with the information output device 2, the information generator 1 further has an IP interface for communicating with the web server 5 in the home or on the Internet 4. As a physical/link layer of this IP interface, it is possible to adopt various communication configurations such as wireless LAN based on IEEE standard 802.11, Ethernet, etc. When using the Internet Protocol (IP) as a network layer, it may be IPv4 or may be IPv6.

Further, the information generator 1 and the web server 5 are connected using IP through the Internet 4, for example. The information generator 1 downloads a web application (explained later) from the web server 5 and executes the web application.

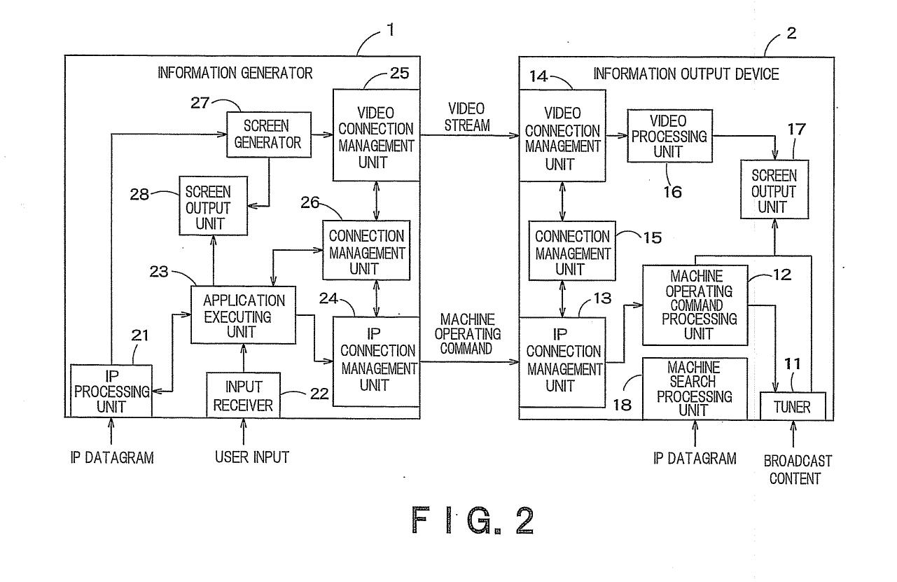

FIG. 2 is a block diagram showing the internal structure of the information generator 1 and the information output device 2 according to the first embodiment. The information output device 2 of FIG. 2 has a tuner 11, a machine operating command processing unit 12, an IP connection management unit (first interface unit) 13, a video connection management unit (second interface unit) 14, a connection management unit 15, a video processing unit 16, a screen output unit 17, and a machine search processing unit 18.

The tuner 11 selects a specific broadcast program and broadcasting information from broadcast waves received by an antenna etc., and performs decoding thereon.

The machine operating command processing unit 12 processes the machine operating command received from the information generator 1 to control the tuner 11, and to transmit an instruction for switching the video etc. to be displayed by the screen output unit 17. That is, the machine operating command processing unit 12 sends a command to switch whether the screen output unit 17 displays the broadcast program received by the tuner 11 or the video data received through the second interface unit, based on an input switching command included in the machine operating command received through the first interface unit.

The IP connection management unit 13 communicates with the information generator 1 to manage a connection for receiving a machine operating command from the information generator 1. The machine operating command is transmitted using a protocol called Websocket (explained later), and thus the IP connection management unit 13 functions as a Websocket server.

The video connection management unit 14 communicates with the information generator 1 to manage a connection for receiving a video stream from the information generator 1.

The connection management unit 15 manages the connections so that the machine operating command connection and the video stream connection are established with the same information generator 1.

FIG. 1 shows a configuration in which the information output device 2 and the information generator 1 are connected one-to-one, but the information output device 2 may be connected to a plurality of information generators 1. In this case, the information output device 2 is required to manage the video stream connections and machine operating command connections corresponding to the number of information generators 1. The connection management unit 15 manages which connection corresponds to which information generator 1.

The video processing unit 16 performs a processing for generating a screen, based on the video stream from the information generator 1. For example, the video processing unit 16 performs demultiplexing, decoding, etc. on the video stream. When the video stream connection is based on the WiFi Display standard, the video processing unit 16 decodes H.264 format data received from the information generator 1.

The screen output unit 17 outputs the screen generated by the video processing unit 16 to a liquid crystal monitor or an external output interface (not shown.) The external output interface is an interface such as HDMI (High-Definition Multimedia Interface) connector, composite connector, S-Video connector, component connector, etc.

The machine search processing unit 18 transmits the name and IP address thereof to the information generator 1, responding to a device search request from the information generator 1 (explained later). As a protocol for the machine search, it is possible to use a method determined based on the DLNA (Digital Living Network Alliance) standard or the UPnP (Universal Plug and Play) standard, or to use a name search method based on NetBIOS (Network Basic Input Output System). Note that the machine search processing unit 18 is not an essential component.

The information generator 1 of FIG. 2 has an IP processing unit 21, an input receiver 22, an application executing unit 23, an IP connection management unit (first interface unit) 24, a video connection management unit (second interface unit) 25, a connection management unit 26, a screen generator 27, and a screen output unit 28.

The IP processing unit 21 performs a processing of reading web application resource files such as HTML files and JavaScript files (registered trademark) encapsulated in IP datagrams from the web server 5 on the Internet 4 or a local network through a network interface and a processing of inputting moving image contents. The IP processing unit 21 transmits the web application to an application executing unit 23. The IP processing unit 21 transmits moving image content to the screen generator 27. Here, the web application is an application including HTML4 files, HTML5 files, JavaScript files, still image data, text data, etc., and executed by a Web browser.

The input receiver 22 receives information inputted by the user through an input tool such as touchpad, keyboard, mouse, etc., and notifies the inputted information to the application executing unit 23.

The application executing unit 23 executes a web application downloaded from the Internet 4 through the IP processing unit 21 or a web application stored in a data storing unit (not shown) in the information generator 1, by using a Web browser, and generates a screen. This will be explained in detail later. Note that the data storing unit is a storage for storing web applications, and is implemented by flash memory SD card, hard disk, etc. The application executing unit 23 outputs the generated screen to the screen output unit 28.

The IP connection management unit 24 communicates with the information output device 2 to manage the connection for transmitting a machine operating command to the information output device 2. The machine operating command is transmitted using a protocol called Websocket, which is determined based on the RFC6455 standard, and the IP connection management unit 24 performs communication processing for the transport layer and the lower layers (TCP/IP layer and physical layer).

The video connection management unit 25 communicates with the information output device 2 to manage the connection for transmitting a video stream to the information output device 2.

The connection management unit 26 checks and manages the connections so that the machine operating command connection established by the IP connection management unit 24 and the video stream connection established by the video connection management unit 25 are established with the same information output device 2.

The screen generator 27 converts the moving image content inputted from the IP processing unit 21 into a format to be transmitted by the video connection management unit 25.

The screen output unit 28 displays the screen generated by the application executing unit 23 on the monitor of the information generator 1, or outputs it to an external output interface. The screen output unit 28 may output moving image data generated by the screen generator 27.

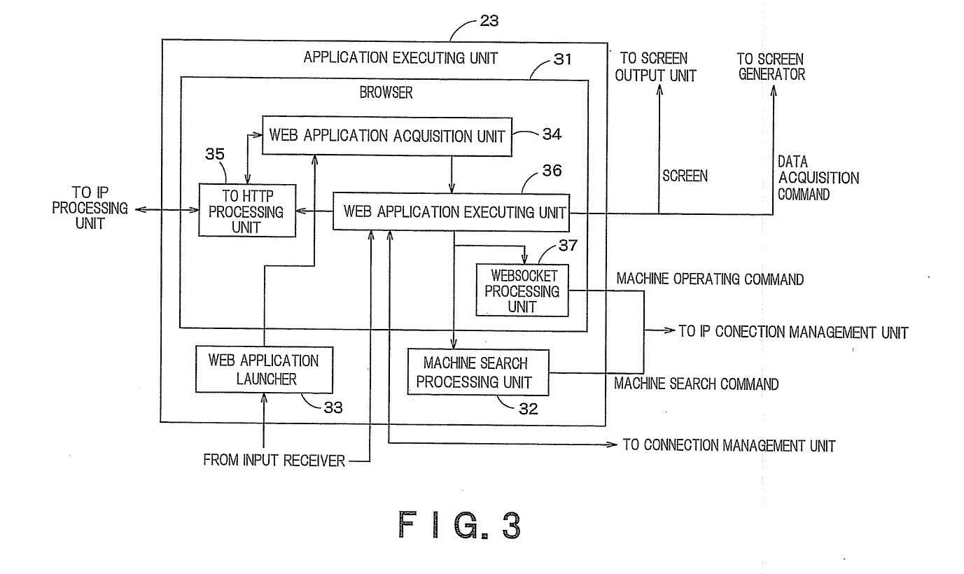

FIG. 3 is a block diagram showing an example of the internal structure of the application executing unit 23 in the information generator 1. The application executing unit 23 of FIG. 3 has a browser 31, a machine search processing unit 32, and a web application launcher 33.

In more detail, the browser 31 has a web application acquisition unit 34, an HTTP processing unit 35, a web application executing unit 36, and a Websocket processing unit 37. The application executing unit 23 may further has a screen display processing unit and a parsing processing unit for analyzing HTML and XML, in addition to the components shown in FIG. 3. However, these components are omitted in FIG. 3 for simplification.

The HTTP processing unit 35 acquires a web application from the URL specified by the web application acquisition unit 34 through the network in accordance with the HTTP (or HTTPS) protocol. Note that the processes for the TCP layer and the lower layers are performed by the IP processing unit 21.

The web application acquisition unit 34 acquires the web application selected by the input receiver 22 from the web server 5 on the Internet 4 or from the data storing unit (not shown) of the information generator 1.

The information generator 1 displays, on the screen of the screen output unit 28, a list of web applications which can be selected by the user (first screen output unit), and lets the user select an arbitrary web application from the list by utilizing an input tool such as a touchpad and a mouse (application selector).

The web application launcher 33 transmits a URL to the web application acquisition unit 34, and the web application executing unit 36 accesses this URL to start up a web application.

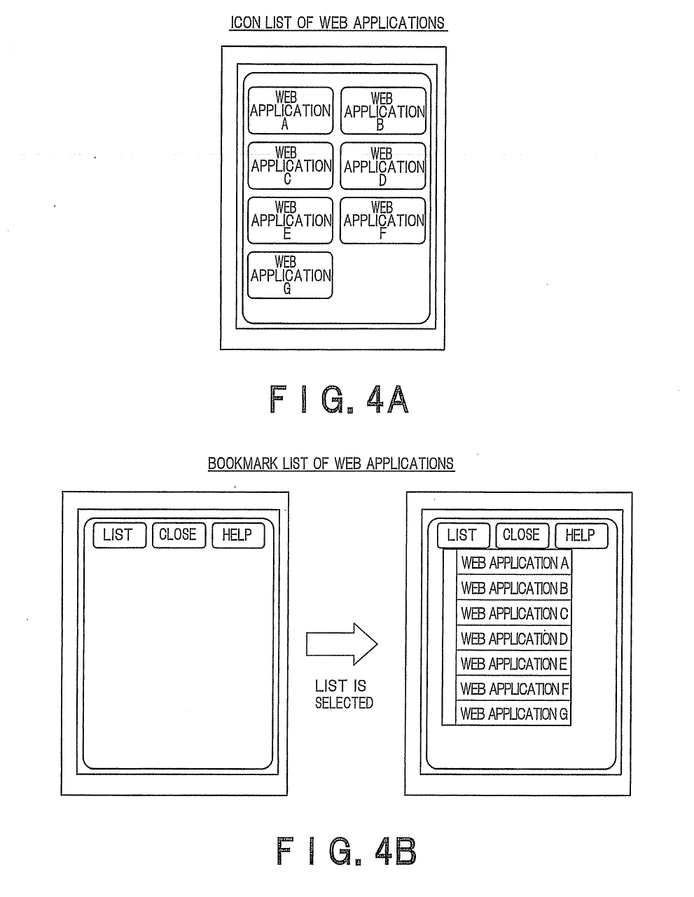

Each of FIGS. 4A, 4B, and 4C is a diagram showing a display example of a web application list to be displayed on the screen of the screen output unit 28. Each of FIGS. 4A to 4C shows a different display example. Here, explanation will be given on an example where a web application is stored in the web server 5 on the network outside the information generator 1, and the information generator 1 downloads the web application through the network by using the IP processing unit 21.

FIG. 4A shows an example where web applications are listed as icons. When the user selects a launcher application (not shown) for example, the input receiver 22 notifies the web application launcher 33 of the selection, and the web application launcher 33 starts up the browser 31. The browser 31 displays a list of web applications (icon list of web applications (FIG. 4A)). The web application selected by the user using the input receiver is notified to the web application acquisition unit 34. That is, the icon of each web application is a link to the position (URL) where the web application is stored. The web application acquisition unit 34 acquires the URL corresponding to web application A, and instructs the HTTP processing unit 35 to acquire the web application from the specified URL.

When link information of each web application is shown on the screen as shown in FIG. 4A, correspondence information showing which web application corresponds to which URL is stored in a database (not shown) together with the icon of each web application. The web application acquisition unit 34 acquires the URL of the selected web application based on the database.

FIG. 4B shows an example where web applications are listed as bookmarks of the browser. When the user pushes the bookmark list button (“list” button) of the browser, a list of web applications installed in the information generator 1 is displayed. The bookmark of each web application can be registered or deleted by utilizing the bookmark management function of the browser. Registering a web application means managing the correspondence between a web application name and a web application URL in a database (not shown) of the browser 31 so that the list of web application names is displayed when the list button is pushed. To the contrary, deleting a web application means deleting a web application name and its corresponding URL from the database (not shown) of the browser 31. The application for displaying the list button, close button, and help button shown in FIG. 4B may be a web application, or may be an application unique to the platform of the information generator 1. When the application is a web application, it is executed by the browser 31, while when the application is an application unique to the platform of the information generator 1, the application is executed by a native application executing unit 23 (not shown). When the user selects a web application (e.g., web application A) from the web application list, the input receiver 22 notifies the web application acquisition unit 34 that web application A has been selected. The web application acquisition unit 34 acquires the URL corresponding to web application A from the database (not shown) of the browser 31, and instructs the HTTP processing unit 35 to acquire the web application from the specified URL.

FIG. 4C shows an example where the web application launcher 33 and a web application correspond to each other one-to-one, and the web application is started up by the web application launcher 33. In this case, the user firstly executes the web application launcher 33 (here, Application 2) in the information generator 1. When Application 2 is started up, Application 2 displays a list of web applications managed thereby. When the user selects a web application (e.g., web application A) from the list, the web application launcher 33 acquires the URL corresponding to web application A, and starts up the browser 31. The web application acquisition unit 34 of the browser 31 acquires the URL from Application 2, and instructs the HTTP processing unit 35 to acquire the web application from the specified URL. In this example, Application 2 manages a plurality of web applications, but Application 2 may manage only one web application. That is, when Application 2 is started up, the web application launcher 33 corresponding to Application 2 may start up the browser to set the URL of the web application managed by the web application launcher 33 in the web application acquisition unit 34 of the browser 31.

As shown above, based on any one of the techniques shown in FIGS. 4A to 4C, the web application acquisition unit 34 of the browser 31 acquires a URL, and notifies the web application executing unit 36 about an HTML file to be executed firstly.

The web application executing unit 36 of FIG. 3 executes the web application acquired by the web application acquisition unit 34 through the HTTP processing unit 35. As stated above, the web application is formed of the resources such as HTML4 files, HTML5 files, JavaScript files, still image data, etc., and the web application acquisition unit 34 notifies the web application executing unit 36 about the HTML file to be executed firstly. The HTML file describes which resource should be acquired from which URL. The web application executing unit 36 interprets the HTML file, acquires the resources described in the HTML file, creates a screen layout, and outputs the screen to the screen output unit 28. An example of the screen configuration of the web application will be explained later.

The Websocket processing unit 37 transmits a machine operating command to the information output device 2 through the IP connection management unit 24. Some web applications include a machine operating command for the information output device 2 as a program. Here, explanation will be given on an example where the program includes a command for instructing switch-over of the input of the information output device 2 from the tuner 11 to the video connection management unit. For example, this command is described using the following JavaScript program code included in the web application.

var ws = new WebSocket(“ws://server/input_service”);
ws.onopen = function( ){
ws.send(“change input from tuner to network”);
};

The web application executing unit 36 interprets the above command and instructs the Websocket processing unit 37 to transmit the text string “change input from tuner to network” to the information output device 2 (server/input_service) in accordance with the Websocket protocol. The Websocket processing unit 37 transmits, to the information output device 2, the above text string specified by the web application together with header information etc. added in accordance with the protocol defined based on the RFC 6455 standard. Also in the Websocket transmission, the processes for the TCP layer and the lower layers are performed by the IP processing unit 21.

The connection management unit 26 checks, based on the request from the web application, whether there is a video stream connection corresponding to the machine operating command connection, and notifies the checking result to the web application executing unit 36, and then the web application executing unit 36 notifies the web application of the result.

The machine search processing unit 32 searches, based on the request from the web application, whether there is another device such as the information output device 2 on the network. Concretely, the web application executing unit 36 transmits a machine search request to the machine search processing unit 32 based on the request from the web application, and the machine search processing unit 32 notifies the web application executing unit 36 of the search result, and then the web application executing unit 36 notifies the web application of the result. At present, W3C and IETF do not define common API specifications for searching a machine, and thus this process is not performed by the browser 31 but by the application executing unit 23. How to search a machine will be explained in detail later.

### (Connection Establishment Phase)

First, explanation will be given on the process for establishing a connection between the information generator 1 and the information output device 2. The information generator 1 and the information output device 2 share two kinds of connections, which are a connection for transmitting a video stream and a connection for transmitting a machine operating command. In a setup phase, information required for establishing these two kinds of connections between the information output device 2 and the information generator 1 is collected. Hereinafter, explanation will be given on the process for determining a combination of one information output device and one information generator 1, but one information generator 1 may be connected to a plurality of information output devices 2.

There are four kinds of techniques for determining the combination of the information output device 2 and the information generator 1, as follows.

(1) Connections are managed by a web application.
(2) The video stream connection is established using the machine operating command connection previously established.
(3) The machine operating command connection and the video stream connection are established using the UPnP Discovery protocol.
(4) Connections are separately set by the information output device 2 and the information generator 1.

In the above case (1), the web application executed by the information generator 1 manages the IP address or DNS host name of the information output device 2 and the port numbers used for the video stream connection and the machine operating command connection. The technique of (1) can be used in the following cases, i.e. when the information generator 1 functions as a DHCP server and generates the IP address of the information output device 2; when the IP address of the information output device 2 is fixed; when the name (DNS host name) of the information output device 2 is fixed and the information generator 1 can acquire the IP address of the information output device 2 through a DNS server (not shown); when the information output device 2 notifies its IP address to a server (not shown) and the information generator 1 can acquire the IP address of the information output device 2 from the server; and when the port numbers used for the video stream connection and the machine operating command connection are defined in specifications etc.

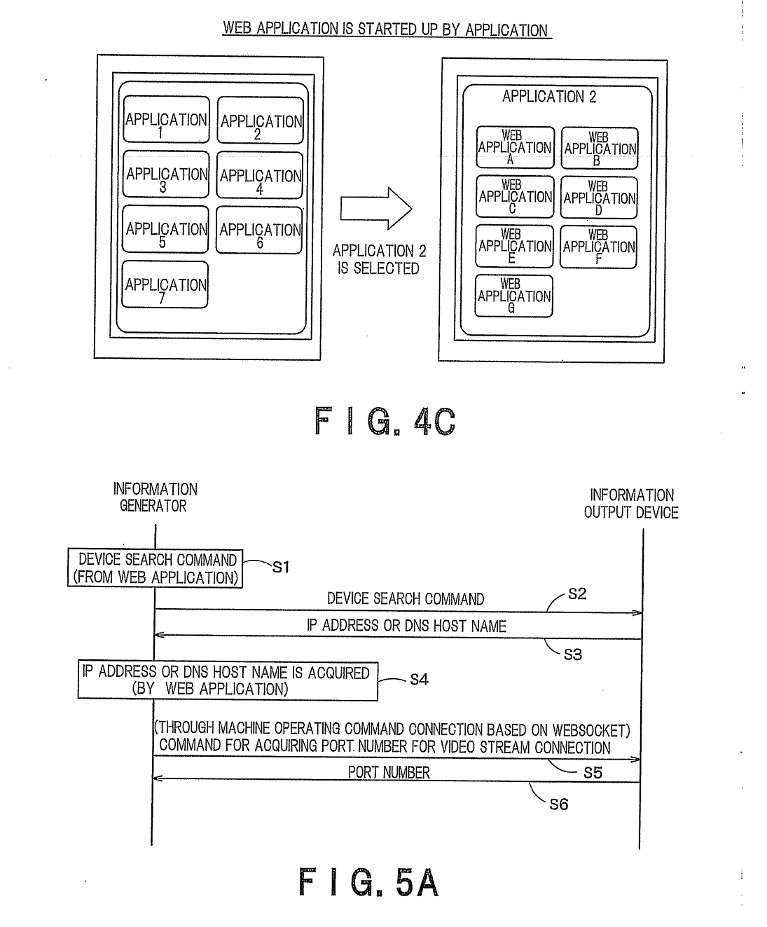

In the above case (2), the port number used for the machine operating command connection is firstly defined in specifications etc. Next, as shown in FIG. 5A, the information generator 1 executes a web application by the web application executing unit 36, and if the web application includes a device search command (Step S1), the web application executing unit 36 broadcasts the device search command to the devices on the same network by using the machine search processing unit 32 (Step S2).

When the information output device 2 transmits its IP address or DNS host name responding to this device search command (Step S3), the information generator 1 acquires the IP address or DNS host name (Step S4).

Note that the information generator 1 can acquire the IP address or DNS host name of the information output device 2 by using any one of the techniques shown in the above case (1). When the information generator 1 acquires the IP address or DNS host name of the information output device 2, the information generator 1 establishes a machine operating command connection (Websocket connection) with the information output device 2 by using the port number defined in specifications etc., as stated above. Further, the information generator 1 transmits, to the information output device 2, a command for acquiring the port number for the video stream connection by using the machine operating command connection (Step S5).

The information generator 1 acquires the port number transmitted from the information output device 2 to be used for the video stream connection (Step S6). In this case, the information output device 2 functions as a server for the machine operating command connection and the video stream connection. When the web application of the information generator 1 acquires the port number of the information output device 2 used for the video stream connection by using the machine operating command connection (Websocket connection), the following JavaScript program code is included in the web application, for example.

var ws = new WebSocket(“ws://server/input_service”);
ws.onmessage = function(event){
var port_number = event.data;
};

FIG. 5B shows another technique, in which the information generator 1 establishes a machine operating command connection (Websocket connection) with the information output device 2, and notifies its port number used for a video stream connection to the information output device 2 by using the machine operating command connection (Step S7), and then the information generator 1 instructs the information output device 2 to establish a video stream connection. In this case, the information output device 2 functions as a server for the machine operating command connection, and the information generator 1 functions as a server for the video stream connection. When the web application of the information generator 1 notifies the information output device 2 that its port number used for the video stream connection is 10000 by using the machine operating command connection (Websocket connection), the following JavaScript program code is used, for example.

var ws = new WebSocket(“ws://server/input_service”);
ws.onopen = function( ){
ws.send(“10000”);
};

In the above explanation, the information output device 2 has the same IP address both for the machine operating command connection and for the video stream connection, but the information output device 2 may have a different IP address for each connection. In this case, the information generator 1 may acquire not only the port number but also IP address for the video stream connection by using the machine operating connection.

In the above case (3), as shown in FIG. 5C, the information generator 1 searches and acquires the IP address of the information output device 2 connected to the network prior to establishing a video stream connection and a machine operating command connection (Steps S1 to S3). The information output device 2 can be searched by using a well-known method such as the NetBIOS protocol and the UPnP Discovery protocol determined based on the DLNA standard or UPnP standard. The information generator 1 and the information output device 2 may support a plurality of methods for searching a machine. The machine search command using this UPnP Discovery is realized as JavaScript API and provided from the application executing unit 23 to a web application. An example of API used by a web application to search a machine is shown below. Here, “type” shows the type of device to be searched (here, the information output device 2), and the return value shows a device list as a search result. Note that the device type is not essential, and a list of all devices existing on the network may be acquired.

### Array UPnPsearchDevice(String Type);

The web application utilizes this API to acquire a list of IP addresses of the devices existing on the network. This API may be automatically executed by the web application without user's approval, or may be executed to acquire a device list when the user pushes a device search button. When the web application acquires a device list, the list is presented to the user. The user selects, from the list, a device to be connected (Step S8). Note that the processing of selection by the user may be omitted when the search result shows that only one information output device 2 is found on the network, or when connection should be established with a device previously set.

Next, in order to establish a video stream connection with the specified device, the information generator 1 acquires, from the information output device 2, the IP addresses and port numbers used for the machine operating command connection (Websocket connection) and for the video stream connection, by using the UPnP Discovery protocol (Steps S9 to S10). When the same IP address is used both for the machine operating command connection and for the video stream connection, only the port numbers may be acquired. Further, when port numbers used for the video stream connection and the machine operating command connection are defined in specifications etc., the process of acquiring port numbers may be omitted.

In the above case (4), a connection for transmitting a video stream and a connection for transmitting a remote control command may be manually set by the user using a setting application etc., or may be preliminarily set before shipment of the device.

When the connection management unit 26 has completed establishing a machine operating connection and a video stream connection with the information output device 2, the connection management unit 26 may store the IP address and port number of the information output device 2 for each connection. In this case, the connection management unit 26 stores occurrence of an error state when the machine operating connection or the video stream connection is disconnected.

In each of the cases (1) to (4), when establishing the machine operating command connection, an authentication key should be exchanged through the video stream connection to protect the copyright of the content, regardless of whether or not to transmit a video stream. For example, if utilizing HDMI or WiFi Display in the video stream connection, when establishing the machine operating command connection, an HDCP (High-bandwidth Digital Content Protection) authentication process should be performed through the video stream connection, regardless of whether or not to transmit a video stream through the video stream connection. This makes it possible for the information generator 1 to start transmitting content at high speed, since the authentication key has already been shared thereto at that point.

(Utilization Phase)

Next, explanation will be given on how to establish two kinds of connections for transmitting a video stream and for transmitting a machine operating command between the information generator 1 and the information output device 2, how to control the information output device 2 from the information generator 1, and how to transmit a video stream from the information generator 1 to the information output device 2.

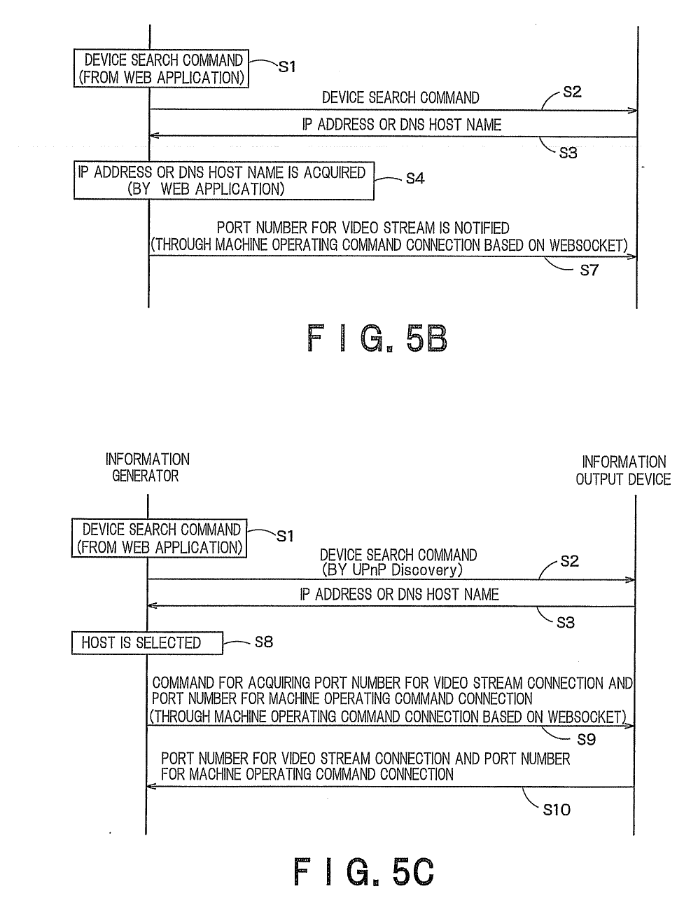

First, as an initial state, it is assumed that the information output device 2 is outputting, to the screen output unit 17, broadcast content inputted into the tuner 11. Further, it is assumed that the information generator 1 is executing a web application by the web application executing unit 36. FIG. 6 shows an example of a screen of web applications displayed on the information generator 1. In FIG. 6, the web application executing unit 36 communicates with the web server 5 on the Internet 4, and executes a web application for acquiring and displaying a thumbnail list of moving image content stored in the web server 5. Note that a URL showing the location of the moving image content is embedded in each thumbnail in the screen.

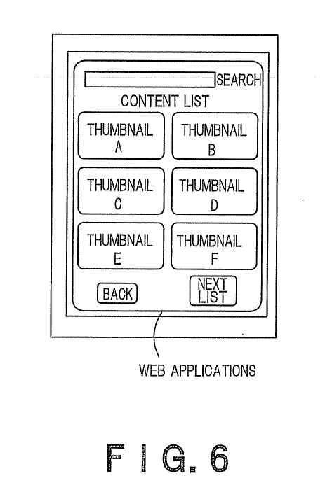

FIG. 7 is a sequence diagram showing processing steps performed by the information generator 1 and the information output device 2 according to the first embodiment. FIG. 7 shows processing steps performed when the user selects a specific thumbnail from the screen of FIG. 6.

When the information generator 1 starts up a web application (Step S21), the web application executing unit 36 displays, based on a command from the web application, a thumbnail list as shown in FIG. 6 by the screen output unit 28 in the information generator 1 (Step S22, third screen output unit).

When the user selects a specific thumbnail by the input receiver 22 (e.g., touch panel) in the information generator 1 (Step S23), the input receiver 22 notifies the web application executing unit 36 which thumbnail has been selected. The web application executing unit 36 notifies the selected thumbnail to the web application, and the web application uses the web application executing unit 36 to instruct the Websocket processing unit 37 to transmit a machine operating command to the information output device 2 through the machine operating command connection. In this way, an input switching command for switching the input into the screen output unit 17 of the information output device 2 from the tuner 11 to the video processing unit 16 is transmitted from the information generator 1 to the information output device 2 by using the machine operating command connection (Websocket connection) (Step S24).

The information output device 2 displays information received from the tuner 11 by the screen output unit 17 until receiving the input switching command (Step S25). The information output device 2 receives the input switching command from the information generator 1 through the machine operating command connection (Websocket connection), analyzes the received command (Step S26), and upon recognizing that the received command is an input switching command, switches the input into the screen output unit 17 from the tuner 11 to the video processing unit 16 (Step S27). This processing is performed when the machine operating command processing unit 12 transmits a switching command to the screen output unit 17.

Next, the web application of the information generator 1 checks whether a video stream connection is established with the information output device 2, by using the web application executing unit 36 (Step S28). This process is performed by the connection management unit 26 based on an instruction from the web application. A specific processing will be shown below.

When the connection management unit 26 stores the IP addresses and port numbers for the machine operating connection and video stream connection with the information output device 2, the web application inquires of the connection management unit 26 about the information through the web application executing unit 36, and confirms that the current state is not an error state. When confirmed that the current state is the error state, the web application performs error processing. This error processing may be performed to notify the user that an error has occurred, or to execute the connection establishment phase again.

When the connection management unit 26 does not store the IP addresses and port numbers of the information output device 2 and the information output device 2 uses the same IP address for the machine operating command connection and for the video stream connection, the web application notifies the IP address for the machine operating command connection to the connection management unit 26 through the web application executing unit 36. The connection management unit 26 acquires the IP address of the information output device 2 from the video connection management unit 25, and checks whether the two IP addresses are consistent with each other. The connection management unit 26 transmits the check result to the web application executing unit 36, and the web application acquires the result. If the check result shows that the IP addresses are not consistent with each other, the web application performs error processing. This error processing may be performed to notify the user that an error has occurred, or to execute the connection establishment phase again. Instead of letting the connection management unit 26 transmit the check result, it is also possible that the web application transmits a command for inquiring the IP address for the machine operating command connection to the connection management unit 26 through the web application executing unit 36 in order that the connection management unit 26 receives the command, acquires the IP address of the information output device 2 from the video connection management unit 25, and transmits the IP address to the web application executing unit 36. Further, it is also possible that the web application acquires the IP address through the web application executing unit 36 and performs comparison to check whether it is consistent with the IP address for the machine operating command connection.

When the connection management unit 26 does not store the IP addresses and port numbers of the information output device 2 and the information output device 2 uses a different IP address for the machine operating command connection and for the video stream connection, the web application inquires of the connection management unit 26 whether the communication partners are the same information output device 2 through the web application executing unit 36. More specifically, the connection management unit 26 inquires of the information output device 2 about the IP address and port number for the video stream connection by utilizing the machine operating command connection, and acquires, from the video connection management unit 25, the IP address and port number of the information output device 2, in order to check whether those are consistent with each other. The check result may be notified to the web application through the web application executing unit 36.

When no video stream connection is established, a video stream connection is established with the information output device 2 based on the information inputted in the setup phase (IP address (or DNS host name) and port number) (Step S29). When a video stream connection has been already established, this processing is omitted. At this time, considering the case of transmitting content protected by copyright, the conventional method may be applied to provide protection for preventing the data transmitted through the connection from being illegally copied and modified.

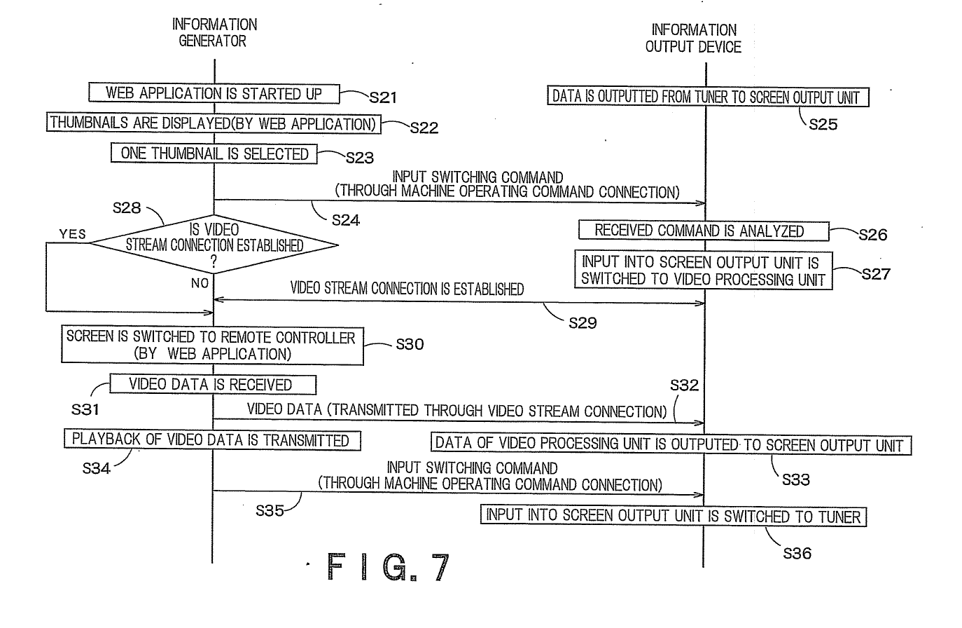

Next, the web application of the information generator 1 uses the web application executing unit 36 to switch from a display screen displaying the thumbnail list shown in FIG. 6 to a display screen displaying a moving image playback controller as shown in FIG. 8 to control the screen of the information output device 2 (Step S30). This switch is realized by page transition of the web application. That is, the web application realizes the screen switching by JavaScript or by transitioning from the URL shown in FIG. 6 to the URL forming the screen of FIG. 8.

As shown in FIG. 8, the screen for the moving image playback controller includes a button for returning to the content list screen (FIG. 6), a volume adjustment button, a time bar, etc. Here, it is intended that a video stream is transmitted from the information generator 1 to the information output device 2 to display the video stream on the information output device 2, and a button (“Return to broadcasting”) may be arranged so that the display of the information output device 2 currently playbacking a video stream can be switched to broadcast content.

The web application of the information generator 1 transitions to the screen of the moving image playback controller and receives a video stream from the web server 5 based on the URL corresponding to the selected thumbnail (Step S31), and then transmits the video stream to the information output device 2 by using the video stream connection (Step S32). That is, when it is confirmed that a video stream connection and a machine operating command connection have been established with the same information output device, the video connection management unit 25 transmits a video stream to the information output device through the video stream connection. The sequence of FIG. 7 shows that the screen is switched to the remote controller screen before transmitting video data, but the screen may be switched to the remote controller screen after starting the transmission of video data. When the WiFi Display standard is applied to the video stream connection, the video data received by the information generator 1 sometimes has a different format from the video data format defined by the WiFi Display standard. In this case, the screen generator 27 in the information generator 1 decodes the video data received from the web server 5, and reencodes it so that the video data has a format based on the WiFi Display standard. When the video content corresponding to the thumbnail is stored in the data storing unit (not shown) in the information generator 1, the information generator 1 should directly transmits the video stream stored therein to the information output device 2, instead of receiving the video stream from the web server 5.

The information output device 2 decodes the video stream based on the WiFi Display standard received from the information generator 1 by the video processing unit 16, and outputs data (video) to the screen generator 27 (Step S33, screen switch).

When the information generator 1 receives an end-of-data signal from the web server 5 providing the video stream (Step S34), the information generator 1 transmits, to the information output device 2, a command for switching the input into the screen output unit 17 from the video processing unit 16 to the tuner 11 through the machine operating command connection (Websocket connection) (Step S35). The information output device 2 analyzes the received command, and upon recognizing that the received command is an input switching command, switches the input into the screen output unit 17 from the video processing unit 16 to the tuner 11 (Step S36).

When switching the input into the screen output unit 17 from the video processing unit 16 to the tuner 11, the information generator 1 or the information output device 2 may disconnect the connection for transmitting a video stream. Further, before the information generator 1 transmits an input switching command for switching the input into the screen output unit 17 from the tuner 11 to the video processing unit 16 based on an instruction from the machine operating command processing unit 12, the information generator 1 may acquire and store the channel number of the broadcast content currently being received by the tuner 11 to give the channel number information to the machine operating command processing unit 12 when the video stream is terminated and the input is switched from the video processing unit 16 to the tuner 11, thereby the original channel number being recovered. In this way, when playback of the content selected by the information generator 1 is terminated, the screen displayed on the information output device 2 recovers the channel of the broadcast content viewed before the input switching, which improves the convenience of the user.

When the information generator 1 receives an end-of-data signal from the web server 5 providing the video stream (Step S34), the information generator 1 may keep the state of transmitting no data from the information generator 1 to the information output device 2 through the video stream connection, without disconnecting the video stream connection.

Further, when the input receiver 22 in the information generator 1 detects the input of “Return to broadcasting” button shown in FIG. 8 before the information generator 1 receives an end-of-data signal from the web server 5, the web application executing unit 36 may instruct the Websocket processing unit 37 to transmit, to the information output device 2, an input switching command for switching the input into the screen output unit 17 of the information output device 2 from the video processing unit 16 to the tuner 11, by using the machine operating command connection (Websocket connection). Further, a channel number may be added to this command.

In the examples explained above, it is assumed that the information generator 1 and the information output device 2 are connected through a wireless LAN and a video stream is wirelessly transmitted (through WiFi Display). However, in the present embodiment, a dongle device may be arranged between the information output device 2 and the information generator 1 so that the information generator 1 wirelessly transmits a video stream to the dongle device and the dongle device transmits the video stream to the information output device 2 through a cable.

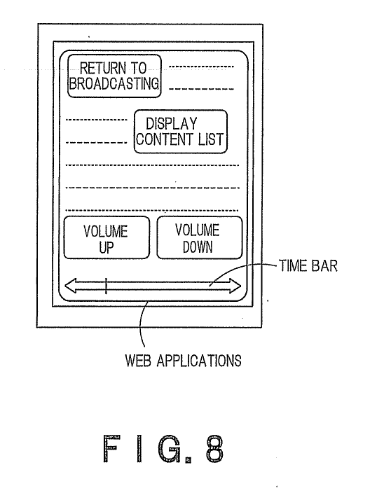

FIG. 9 is a block diagram showing an example of arranging a dongle device 6 between the information generator 1 and the information output device 2. The information output device 2 of FIG. 9 is obtained by omitting the video processing unit 16 from the information output device 2 of FIG. 2. The dongle device 6 has the video processing unit 16, the video connection management unit 14a, and a video output interface processing unit 19. The video output interface processing unit 19 outputs uncompressed video data received from the video processing unit 16 to a cable interface. Here, the cable interface is an interface such as HDMI.

The dongle device 6 can be regarded as a partial information output device 2 arranged in another housing, and the dongle device 6 and the information output device 2 have different IP addresses. In this case, the machine search processing unit acquires the IP address of the dongle device 6 from the video connection management unit. The IP address can be acquired when the video connection management unit 14 communicate with the video output interface of the dongle device 6 utilizing HDMI-CEC.

As in the above case (4), a connection for transmitting a video stream and a connection for transmitting a machine operating command may be manually set by the user using a setting application etc. in the setup phase, but this process is not necessary when these connections are preliminarily set before shipment of the device.

Steps S21 to S28 in FIG. 7 should be similarly performed before a video stream connection is established between the information generator 1 and the dongle device 6. After that, the dongle device 6 receives a video stream from the information generator 1 by using the video connection management unit 14a, decodes the video stream using the video processing unit 16 to convert it into an uncompressed format, and outputs the converted video stream to the video output interface processing unit 19. The video output interface processing unit is connected to the information output device 2 physically one-on-one through a cable, and transmits a video stream in an uncompressed format to the information output device 2.

As stated above, in the first embodiment, the information generator 1 executes a web application by the web application executing unit 36, and transmits a video stream stored therein or acquired from a server on the Internet to the information output device 2 through a video stream connection. The information output device 2 receives this video stream and displays it by switching the screen from a video received by the tuner 11 and viewed until then to the video stream received from the information generator 1. Further, the information generator 1 also switches the output from the screen output unit 28 to display various buttons for controlling the screen display of the information output device 2. Therefore, the user can control the screen display of the information output device by the touchpanel etc. of the information generator 1 instead of operating a remote controller as a standard equipment of the information output device 2, which remarkably improves operability.

More specifically, the information generator 1 transmits, to the information output device 2, an input switching command for switching the input into the screen output unit 17 of the information output device 2 from the tuner 11 to the video processing unit 16, and when the information output device 2 receives the command, the machine operating command processing unit 12 instructs the screen output unit 17 to switch the input from the tuner 11 to the input from the video connection management unit 14.

In the conventional system, when selecting content from a thumbnail list, the user is required to select the content by pushing keys and a cross-shaped key of a TV remote controller. Accordingly, when a large number of thumbnails are displayed in the screen and a key (e.g., scroll key) to be pushed multiple times is displayed, usability is deteriorated. On the other hand, according to the present embodiment, the user can easily select content from a large number of thumbnails by utilizing a user-friendly input tool such as a touchpad arranged in the information generator 1, which improves the convenience of the user.

Further, since the screen displaying a thumbnail list on the information generator 1 is realized by a web application, the appearance and layout of colors and buttons can be changed only by changing CSS (Cascading Style Sheets) included in the web application, without redesigning logic. Accordingly, cost for application implementation can be reduced.

Further, in the conventional methods, when changing the screen layout, it is required to provide new firmware to the information generator 1 in order to update the firmware therein. High cost is required to distribute firmware from a server, and it is difficult to let users simultaneously update firmware. On the other hand, according to the present embodiment, only by modifying a web application stored in a web application distribution server and required to be provided to the information generator 1, a newly updated web application can be simultaneously distributed to a plurality of information generators 1.

Further, by using Websocket as the protocol for transmitting a machine operating command, a machine operating command to another device can be controlled by a web application. That is, a machine operating command for the information output device 2 can be changed by updating the web application distributed from the web server without modifying the firmware and the application executing unit 23 of the information generator 1, which makes it possible to expand functions with ease.

Further, since the information generator 1 transmits a video stream received through the network after converting it into a format for the video stream connection (e.g., format based on the WiFi Display standard), the information output device 2 is required to support only a single video format, which restrains the cost of the information output device 2.

### Second Embodiment

In the first embodiment, the information output device 2 transmits the video data received from the information generator 1 directly to the screen output unit 17. In a second embodiment, the information output device 2 executes a web application by the web application executing unit 36 in the information output device 2 and playbacks video data transmitted from the information generator, in order to simultaneously output the video data and the web application on the screen.

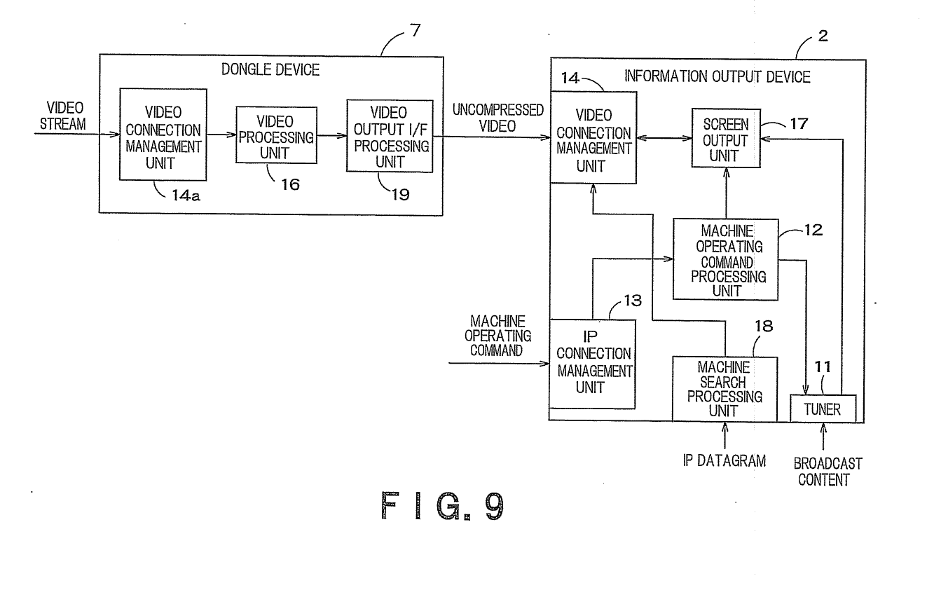

FIG. 10 is a block diagram showing the internal structure of the information output device 2 according to the second embodiment. The information output device 2 according to the second embodiment is different from that shown in FIG. 2 in that an application executing unit 41 and an IP processing unit 42 are provided. The IP processing unit 42 functions similarly to the IP processing unit 21 in the information generator 1 of FIG. 2.

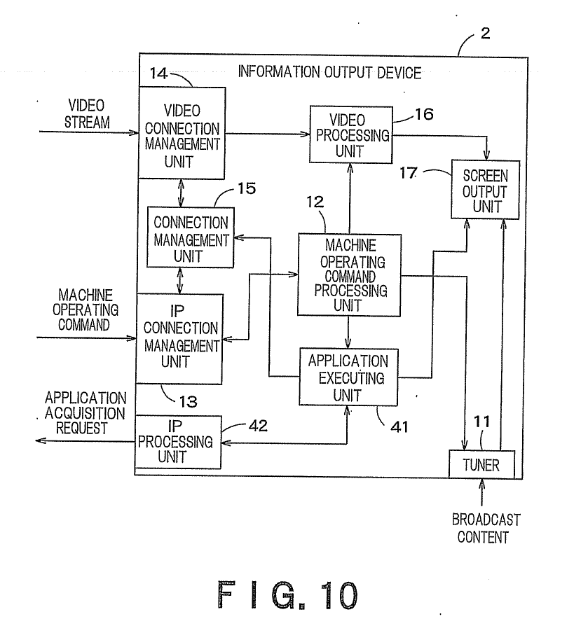

FIG. 11 is a block diagram showing the internal structure of the application executing unit 41 in the information output device 2. The application executing unit 41 of FIG. 11 is different from the application executing unit 23 in the information generator 1 of FIG. 3 in that the machine search processing unit 18 is not provided. The web application acquisition unit 34 of FIG. 11 receives a URL from the machine operating command processing unit 12, and instructs the HTTP processing unit 35 to acquire a web application from the specified URL. The HTTP processing unit 35, web application executing unit 36, and Websocket processing unit 37 function similarly to those shown in FIG. 3.

(When the Information Output Device 2 Acquires a Web Application from the Web Server 5 Arranged Outside the Information Output Device 2)

Next, explanation in the second embodiment will be given on how to establish two kinds of connections for transmitting a video stream and for transmitting a machine operating command between the information generator 1 and the information output device 2, how to control the information output device 2 from the information generator 1, and how to transmit a video stream from the information generator 1 to the information output device 2.

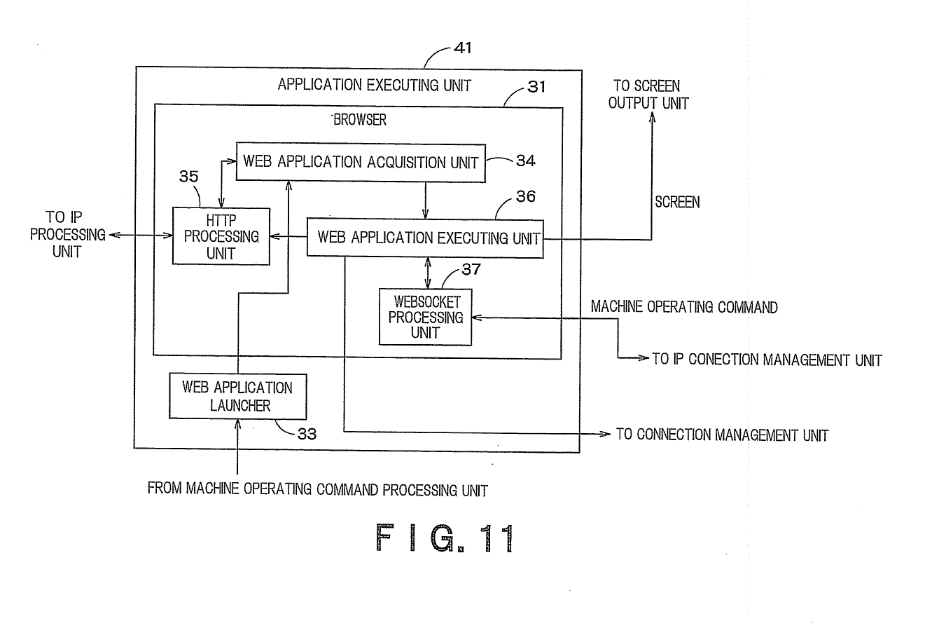

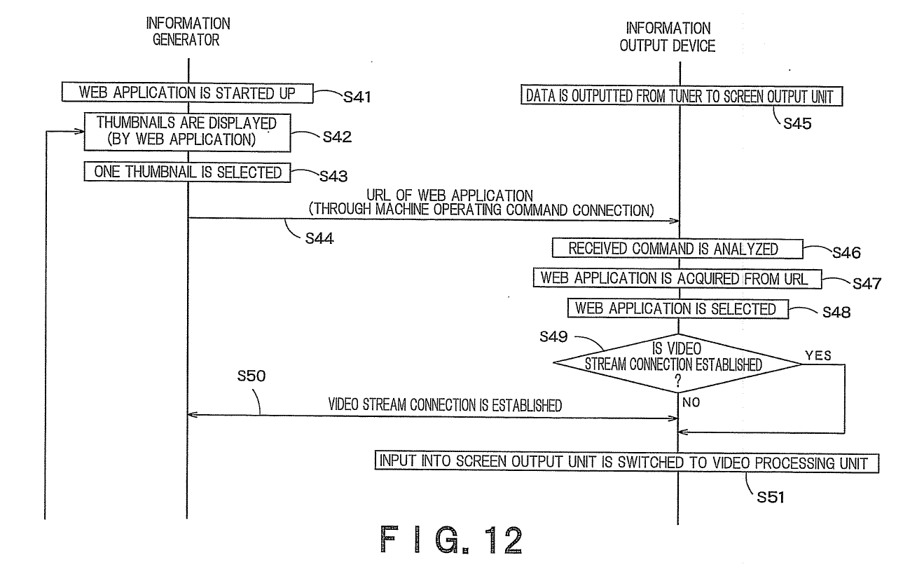

Each of FIGS. 12 and 13 is a sequence diagram showing processing steps performed by the information generator 1 and the information output device 2 according to the second embodiment. Hereinafter, how the information output device 2 displays a moving image selected by the user will be explained using FIG. 12.

The steps performed before the information generator 1 displays a thumbnail list (Steps S41 and S42) are similar to those shown in FIG. 7. When a thumbnail is selected on the information generator 1 (Step S43), the input receiver 22 notifies the web application executing unit 36 which thumbnail has been selected. The web application executing unit 36 notifies the web application of the selected thumbnail, and the web application uses the web application executing unit 36 to instruct the Websocket processing unit 37 to transmit the URL of the web application to the information output device 2 through the machine operating command connection (Step S44). Note that the information output device 2 displays, by the screen output unit 17, the video received by the tuner 11 until receiving this URL (Step S45).

The information output device 2 analyzes the received command (Step S46), and upon recognizing that the received command is a web application acquisition command, transmits the web application acquisition command utilizing the URL received from the information generator 1 to acquire the web application (Step S47). This processing is performed using the web application acquisition unit 34 of the browser 31.

The information output device 2 downloads the web application from the network, and executes the downloaded web application by the web application executing unit 36 (Step S48).

Next, the web application of the information output device 2 checks whether a video stream connection is established with the information generator 1 (Step S49). This processing is performed by the connection management unit 15 based on an instruction from the web application. When no video stream connection is established, the information generator 1 is commanded to establish a video stream connection by using the machine operating command connection (Websocket connection) (Step S50). In this case, the following JavaScript program code is included in the web application, for example.

var ws=new WebSocket(“ws://server/input_service”);
ws.onopen=function( ){
ws.send(“establish stream connection”);
   };

Note that the information output device 2 is not required to transmit the above command when the information generator 1 transmits the URL of the web application together with information for establishing a video stream connection so that the information output device 2 can transmit, to the information generator 1, a request for establishing a video stream connection. When a video stream connection has been already established, these processes are omitted.

Next, the web application executed by the application executing unit 41 of the information output device 2 instructs the screen output unit 17 to switch the input thereinto from the tuner 11 to the video processing unit 16 by using the application executing unit 41 (Step S51), and transmits a request for starting playback of a video stream through the machine operating command connection (Websocket connection) (Step S52).

The information generator 1 receives the playback start request, acquires a video stream from the URL corresponding to the selected thumbnail through the network or acquires a video stream stored therein (Step S53), and transmits the video stream to the information output device 2 through the video stream connection (Step S54).

The information output device 2 playbacks the video stream inputted thereinto, and outputs it to the screen output unit 17 (Step S55).

When the information generator 1 receives an end-of-data signal from the web server 5 providing the video stream (Step S56), the information generator 1 notifies the information output device 2 that the video stream has been terminated through the machine operating command connection (Step S57).

When the web application of the information output device 2 uses Websocket to receive, from the information generator 1, a notification that reception of the video stream has been completed, the following JavaScript program code is included in the web application of the information output device 2, for example.

var ws=new WebSocket(“ws://server/input_service”);
ws.onmessage=function(event){
var end_data=event.data;
   };

The web application of the information output device instructs the application executing unit 41 to switch the input into the screen output unit 17 from the video processing unit 16 to the tuner 11 since reception of the video stream has been completed (Step S58). At this time, the information generator 1 or the information output device 2 may disconnect the video stream connection.

(When the Information Output Device 2 Acquires a Web Application from the Web Server 5 Arranged in the Information Generator 1)

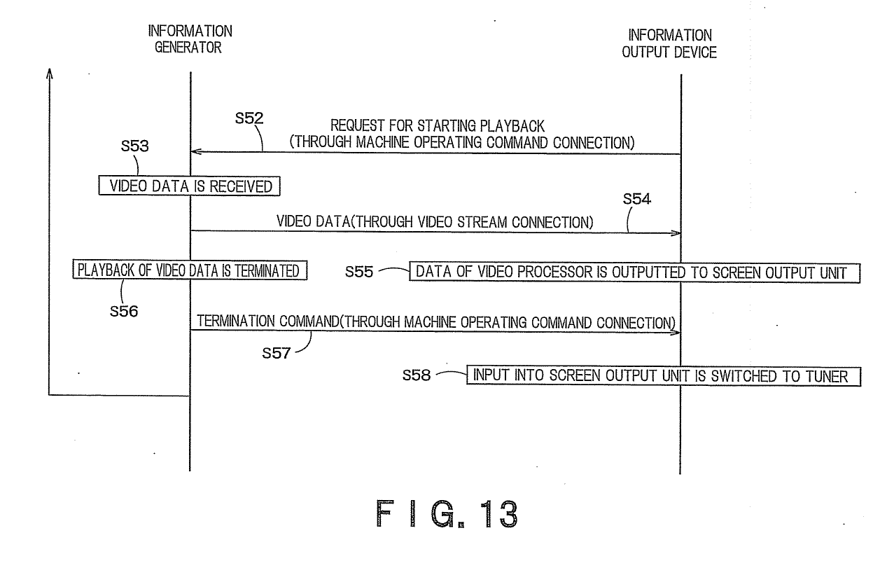

In the processing steps as shown in FIG. 12 and FIG. 13, it is assumed that the web application acquisition unit 34 in the browser 31 in the information output device 2 receives a web application from a server on the Internet 4. However, the information output device 2 may receive a web application from the information generator 1. That is, the host name of the URL transmitted from the information generator 1 to the information output device 2 may indicate the address of the information generator 1. In this case, the internal structure of the information generator 1 is as shown in FIG. 14, which is different from FIG. 2 in that an application distributing unit 29 is arranged. The application distributing unit 29 receives, from the information output device 2, a command to acquire a web application, and provides the web application thereto based on the command.

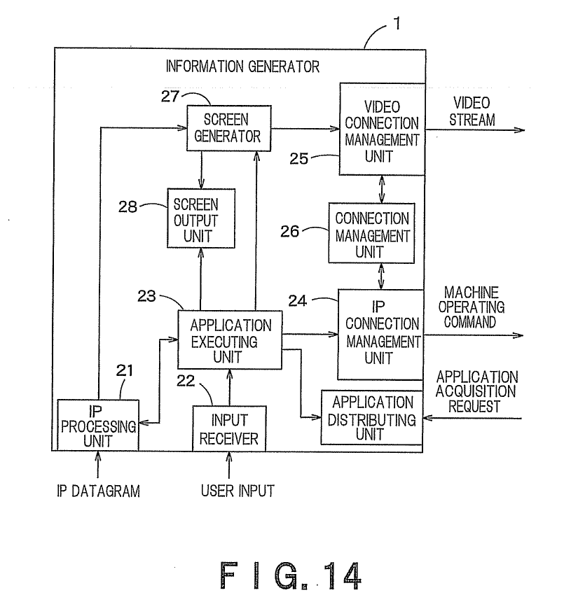

FIG. 15 is a sequence diagram showing the processing steps performed when the web application acquisition unit 34 in the information output device 2 acquires web application from the application distributing unit 29 in the information generator 1 in FIG. 14.

In Steps S61 to S66 of FIG. 15, which are similar to Steps S41 to S46 in FIG. 12, the information generator 1 transmits the URL of a web application to the information output device 2 by using the machine operating command connection. At this time, the application executing unit 23 in the information generator 1 acquires, from the application distributing unit 29, information about the URL storing the web application, and transmits it to the information output device 2.

The information output device 2 receives and analyzes the command, and upon recognizing that the received command is a web application acquisition command, transmits the web application acquisition command utilizing the URL received from the information generator 1 (Step S68), and acquires a web application transmitted from the information generator 1 responding to the web application acquisition command (Step S69). This processing is performed using the web application acquisition unit 34 of the browser 31. The host name of this URL is the address of the information generator 1.

After that, the web application executing unit 41 in the information output device 2 executes the received web application (Step S70), checks whether a video stream connection is established and, if not, establishes the connection, and switches the display of the screen output unit 17 (Steps S71 to S73).

As stated above, in the second embodiment, not only the information generator 1 but also the information output device 2 has the application executing unit 41, which makes it possible to perform the transmission request of the video data from the information output device 2 to the information generator 1.

### Third Embodiment

In the first embodiment and the second embodiment, the information generator 1 transmits a machine operating command to the information output device 2 in accordance with an instruction inputted into the input receiver 22 in the information generator 1. In a third embodiment, state information of the information output device 2 is transmitted to the information generator 1, and the web application executing unit 36 in the information generator 1 transmits a machine operating command to the information output device 2 based on the state information.

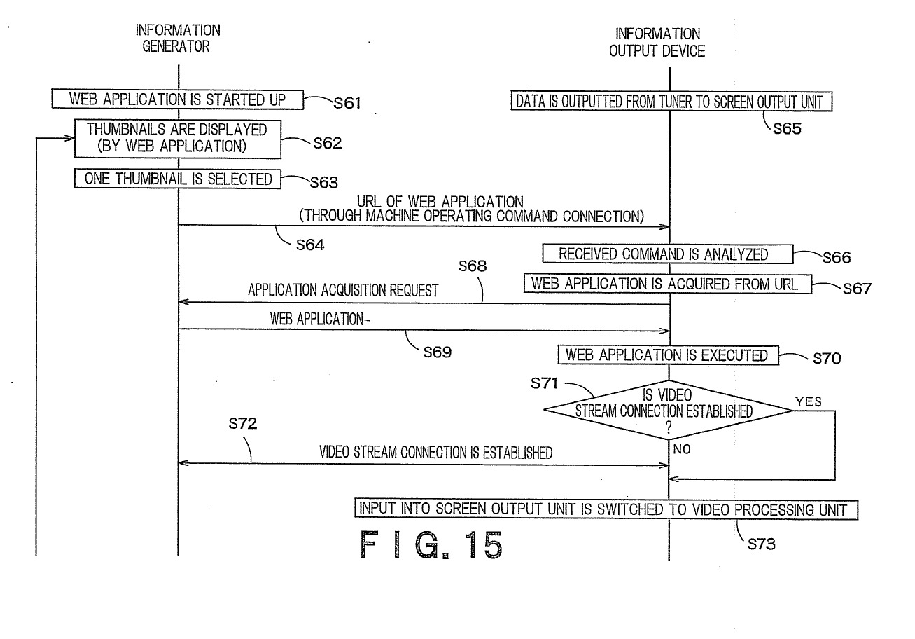

FIG. 16 is a block diagram showing the internal structure of the information output device 2 according to the third embodiment. The information output device 2 of FIG. 16 is different from that shown in FIG. 2 in that an information acquiring unit 43 is provided.

The information acquiring unit 43 acquires the current state of the tuner 11 and channel information about broadcast content received by the tuner 11. That is, based on an instruction from the machine operating command processing unit 12, the information acquiring unit 43 acquires, from the tuner 11, information about the state and channel of the tuner 11 and transmits the information to the machine operating command processing unit.

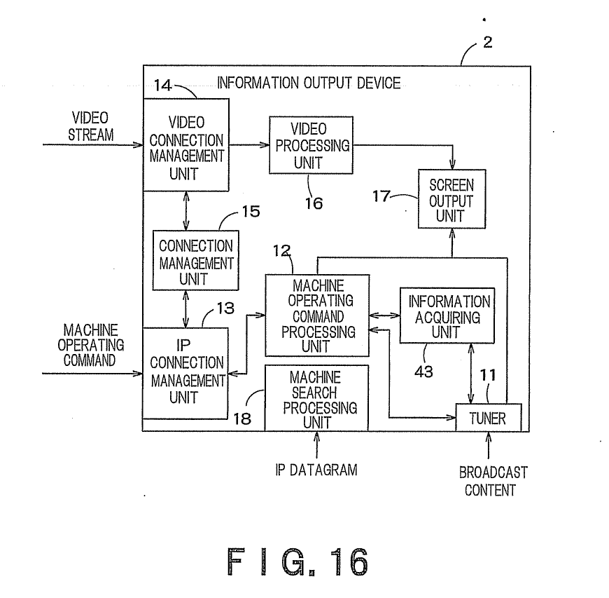

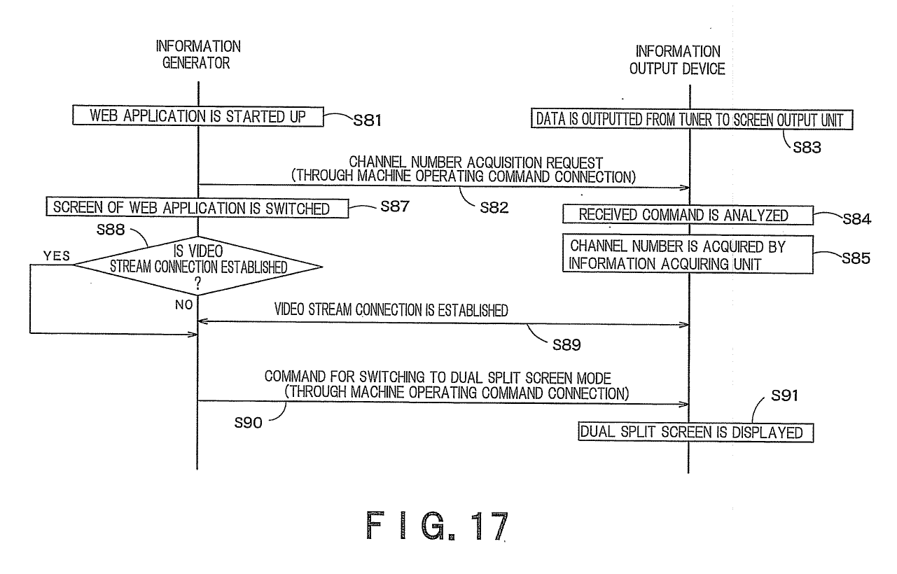

Each of FIGS. 17 and 18 is a sequence diagram showing the processing steps performed by the information generator 1 and the information output device 2 according to the third embodiment, in which the web application executing unit 36 of the information generator 1 transmits a machine operating command to the information output device 2 based on the state information of the information output device 2.

The information generator 1 starts up and executes a web application by the application executing unit 23 (Step S81), and transmits a command to inquire the channel number of broadcast program currently outputted to the screen output unit 17 by the information output device 2, by using the machine operating command connection (Websocket connection) (Step S82). The information output device 2 displays, by the screen output unit 17, the video stream received by the tuner 11 until receiving this command (Step S83).

The information output device 2 receives and analyzes the command (Step S84), and upon recognizing that the received command is a channel number acquisition command, acquires the channel number from the tuner 11 by using the information acquiring unit 43 (Step S85). Then, the information output device 2 transmits the channel number to the information generator 1 by using the machine operating command connection (Step S86, channel number transmitter).

Next, the web application of the information generator 1 generates a screen corresponding to the channel number of the broadcast program (Step S87). It is also possible that the web application of the information generator 1 transmits the channel number to a server (not shown) on the Internet 4 so that the server on the Internet 4 provides a web application to the information generator 1 (the server on the Internet 4 transmits the URL of the web application to the information generator 1). The information generator 1 acquires the URL transmitted from the server (URL acquisition unit), acquires a web application from the acquired URL (application acquisition unit), and the application executing unit 23 switches to the newly acquired web application. This server on the Internet 4 may include, in the web application, program information about the content currently being broadcasted, recommended content, advertising information, etc. Further, the information generator 1 may transmit the channel number to the server together with information about the broadcast receiving area. The information generator 1 executes the web application received from the server on the Internet 4 by the application executing unit 23, and outputs the screen generated by the web application to the screen output unit 17.

The information generator 1 executes the web application by the application executing unit 23, and checks, based on a command from the web application, whether a video stream connection is established with the information output device 2 (Step S88). When no video stream connection is established, the information generator 1 instructs the information output device 2 to establish a video stream connection by using the machine operating command connection (Step S89). Further, the web application transmits a command for switching the information output device 2 to a dual split screen mode through the machine operating command connection (Websocket connection) by using the application executing unit 23 (Step S90).

The information output device 2 receives and analyzes the command, and upon recognizing that the received command is a command for switching to the dual split screen mode, performs setting so that data is inputted into the screen output unit 17 both from the video processing unit 16 and the tuner 11 (Step S91). When the information generator 1 transmits, to the information output device 2, a command for switching to the dual split screen mode, the command may include information about the ratio of each split screen and whether the content inputted from the tuner 11 should be arranged on the right or left so that the information output device 2 receiving the command sets the dual split screen mode utilizing the information.

The screen generator 27 outputs, to the video connection management unit 25, the same screen as that transmitted to the screen output unit 17. Here, the screen generator 27 encodes video data so that the video data has a format to be transmitted through the video stream connection (e.g., format based on the WiFi Display standard) (Step S92), and transmits it to the information output device 2 through the video stream connection (Step S93).

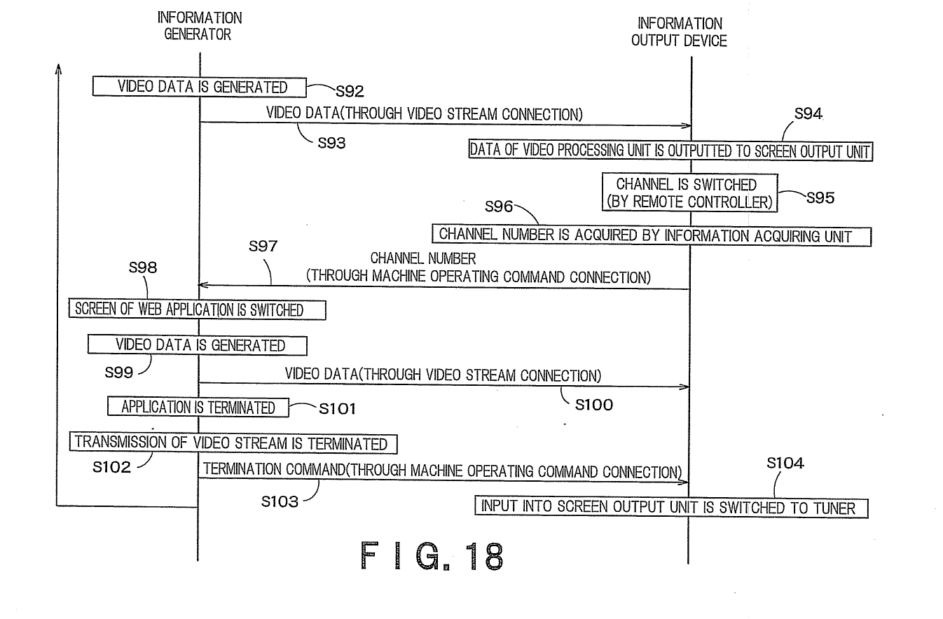

The information output device 2 outputs the data of the video processing unit 16 to the screen output unit 17 (Step S94). FIG. 19 shows an example of the screen generated by the screen output unit 17 in this case.

As shown in FIG. 19, the screen output unit 17 displays two video streams in one screen. One is a video stream inputted from the video processing unit 16, and the other is a video stream inputted from the tuner 11. The video stream inputted from the information generator 1 through the video processing unit 16 is originally the screen displayed by the screen output unit 28 in the information generator 1. In other words, the video stream is the screen of a web application acquired by the information generator 1 shown in FIG. 14 from a server on the Internet 4. Even when the screen of the web application does not change, the information generator 1 continuously transmits the screen of the web application to the information output device 2 as a video stream.

At Step S95 in FIG. 18, the information output device 2 switches a channel by the remote control device shown in FIG. 1 (Step S95). Switching a channel means that the information output device 2 instructs the tuner 11 to switch a broadcast program. The information acquiring unit 43 detects that the channel has been switched by the tuner 11 (Step S96), and notifies the machine operating command processing unit 12 of the switched channel number. The machine operating command processing unit 12 transmits the channel number to the information generator 1 through the machine operating command connection (Websocket connection) by using the IP connection management unit 13 (Step S97).

Upon receiving the channel number, the information generator 1 transmits the channel number to a server (not shown) on the Internet 4 in accordance with the steps as stated above, and receives a web application as a response. Then, the screen of the web application is transmitted to the information output device 2 as a video stream, in accordance with the steps as stated above (Steps S98 to S100).

When the web application is terminated by the input receiver 22 of the information generator 1 (Step S101), transmission of the video stream (screen of the web application) is terminated (Step S102).

The information output device 2 is notified through the machine operating command connection that the web application of the information generator 1 has been terminated (Step S103).

The information output device 2 switches the mode from the dual split screen display mode shown in FIG. 17 to a single screen display mode, and switches the input to the tuner 11 only (Step S104).

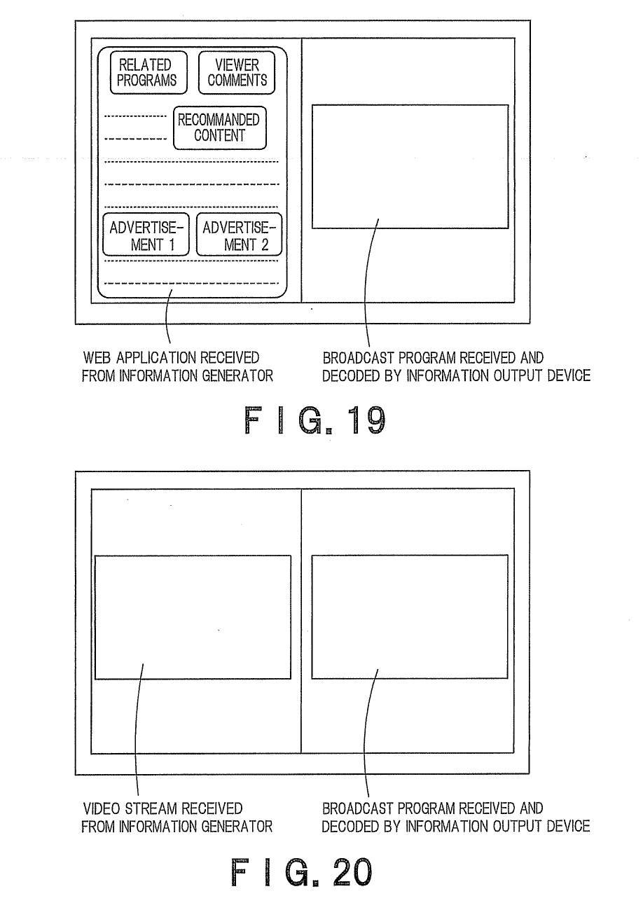

In the examples shown in the above embodiments, the information generator 1 generates the screen of a web application as a video stream, and transmits it to the information output device 2. However, the information generator 1 may transmits, to the information output device 2, a video stream received from a server (not shown) on the Internet 4 so that the information output device 2 receives the broadcast content received by the tuner 11 and the video content received from the information generator 1 in the dual split screen mode and outputs the two kinds of content to the screen output unit 17. FIG. 20 shows a screen display example of the information output device 2 in this case. As shown in FIG. 20, the screen output unit 17 of the information output device 2 receives the broadcast content received by the tuner 11 and the video content received from the information generator 1 in the dual split screen mode, and simultaneously outputs the two kinds of content to the screen output unit 17.

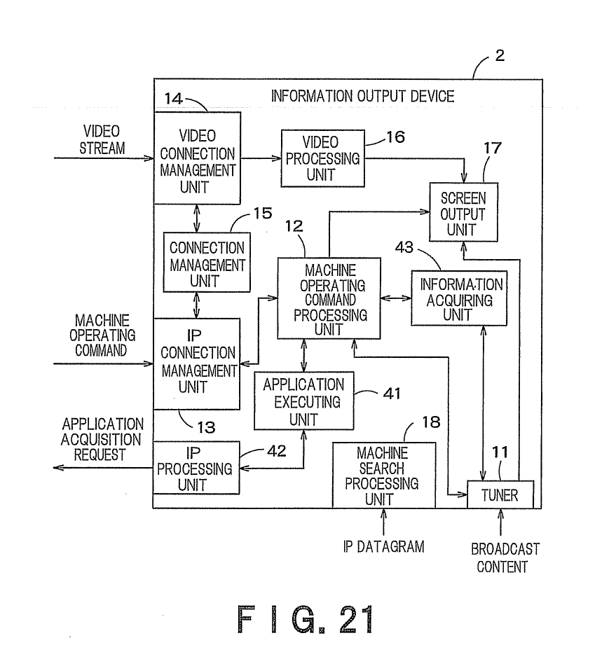

FIG. 21 is a block diagram showing the internal structure of the information output device 2 for realizing the screen display of FIG. 20. The information output device 2 of FIG. 21 is obtained by adding the application executing unit 41 to the information output device 2 of FIG. 16. This application executing unit 41 functions similarly to the application executing unit 41 in the information output device 2 shown in FIG. 10.

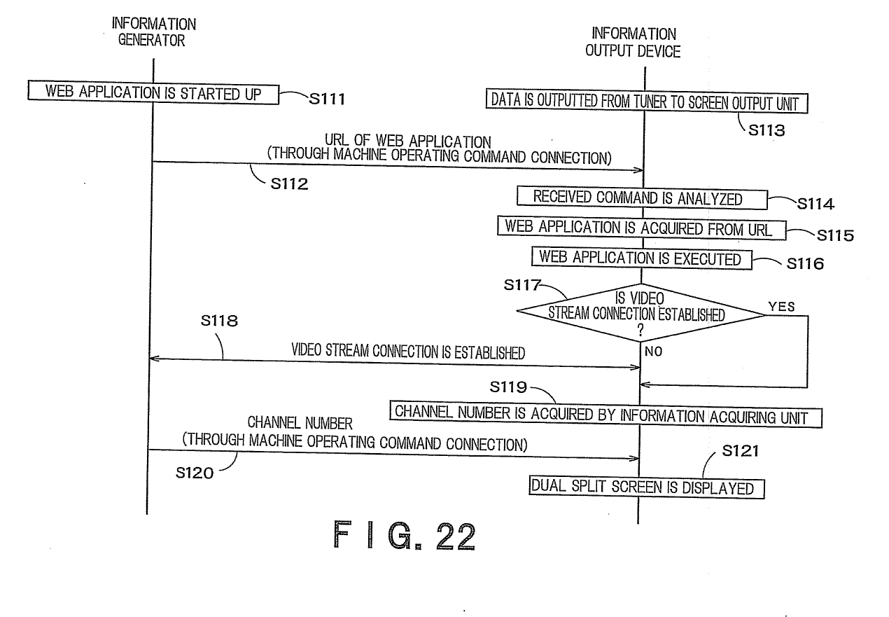

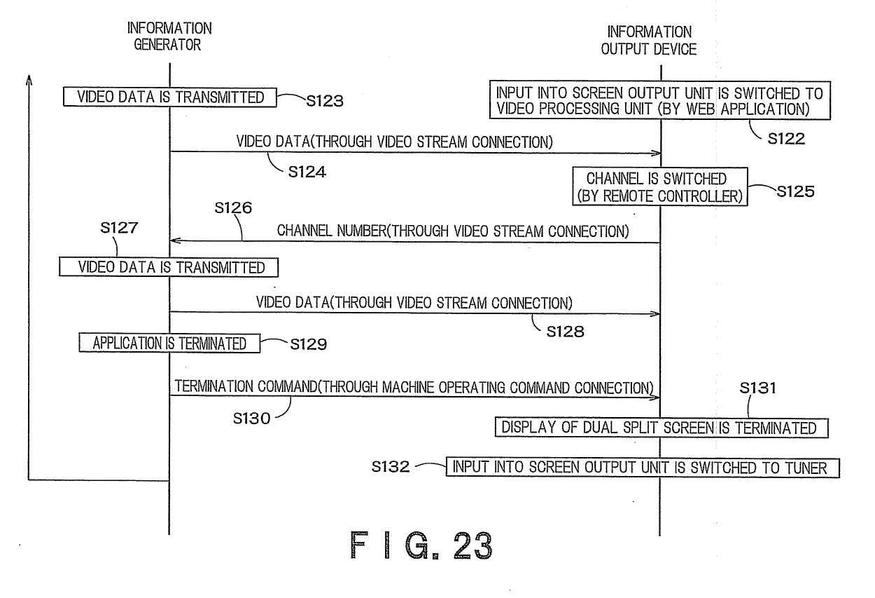

Each of FIGS. 22 and 23 is a sequence diagram showing processing steps performed when the information generator 1 simultaneously displays broadcast content received by the tuner 11 and video content received from the information generator 1 in a dual split screen, by using the information output device 2 of FIG. 21.

First, the information generator 1 starts up a web application (Step Sill). The started-up web application uses the web application executing unit 36 to instruct the Websocket processing unit 37 to transmit the URL of the web application to the information output device 2 through the machine operating command connection (Step S112). The information output device 2 displays, by the screen output unit 17, the video stream received by the tuner 11 until receiving this URL (Step S113).

The information output device 2 analyzes the received command (Step S114), and upon recognizing that the received command is a web application acquisition command, transmits the web application acquisition command utilizing the URL received from the information generator 1 to acquire the web application (Step S115). This process is performed using the web application acquisition unit 34 of the browser 31.

The information output device 2 downloads the web application from the network, and executes the downloaded web application by the web application executing unit 36 (Step S116).

Next, the web application of the information output device 2 checks whether a video stream connection is established with the information generator 1 (Step S117). This process is performed by the connection management unit 15 based on an instruction from the web application. When no video stream connection is established, the information generator 1 is commanded to establish a video stream connection by using the machine operating command connection.

Next, the web application executed by the web application executing unit 36 in the information output device 2 acquires channel information from the tuner 11 through the machine operating command processing unit 12 (Step S119), and transmits the channel number to the screen generator 27 by using the machine operating command connection (Websocket connection) (Step S120). Further, the web application of the information output device 2 switches the mode to the dual split screen mode through the machine operating command processing unit 12 (Step S121), and performs setting so that data is inputted into the screen output unit 17 both from the video processing unit 16 and the tuner 11 (Step S122).

The information generator 1 receives the channel number and receives, from a server (not shown) on the Internet 4, a video stream corresponding to the channel of the broadcast program (Step S123). This is realized when the web application of the information generator 1 transmits a channel number to the server, receives the URL of a video stream as a response, and transmits a video stream acquisition request to the URL. The information generator 1 receives a video stream and transmits it to the information output device 2 by using the video stream connection (Step S124).

Here, the information output device 2 switches a channel by the remote control device shown in FIG. 1 (Step S125). The information acquiring unit 43 detects that the program has been switched by the tuner 11, and notifies the machine operating command processing unit 12 of the switched channel number (Step S126). The machine operating command processing unit 12 transmits the channel number to the information generator 1 through the machine operating command connection by using the IP connection management unit 13.

Upon receiving the channel number, the information generator 1 transmits the channel number to a server (not shown) on the Internet 4 in accordance with the steps as stated above, and receives a video stream as a response (Step S127). Then, the video stream received from the server is transmitted to the information output device 2, in accordance with the steps as stated above (Steps S98 to S128).

When the web application is terminated by the input receiver 22 in the information generator 1 (Step S129), transmission of the video stream is cancelled. The information output device 2 is notified through the machine operating command connection that the web application of the information generator 1 has been terminated (Step S130).

The information output device 2 switches the mode from the dual split screen display mode shown in FIG. 18 to a single screen display mode (Step S131), and switches the input to the tuner 11 only (Step S132).

The processing steps shown in FIGS. 22 and 23 are different from the processing steps shown in FIGS. 17 and 18 in the following points.

1) In the processing steps shown in FIGS. 22 and 23, the information output device 2 executes a web application, while in the processing steps shown in FIGS. 17 and 18, the information output device 2 executes no web application.

2) In the processing steps shown in FIGS. 22 and 23, the video stream connection between the information output device 2 and the information generator 1 is established from the information output device 2, while in the processing steps shown in FIGS. 17 and 18, the video stream connection is established from the information generator 1.

As stated above, in the third embodiment, the channel number of a program received by the information output device 2 is transmitted to the information generator 1, and the information generator 1 acquires a video stream corresponding to the channel number to transmit it to the information output device 2, and then the information output device 2 displays the image received by the tuner 11 and the video stream from the information generator 1 in a dual split screen. This makes it possible to provide information highly attractive to the user in real time, while improving the convenience of the user.

At least a part of the information generator 1 and information output device 2 explained in the above embodiments may be formed of hardware or software. In the case of software, a program realizing at least a partial function of the information generator 1 and information output device 2 may be stored in a recording medium such as a floppy disc, CD-ROM, etc. to be read and executed by a computer. The recording medium is not limited to a portable medium such as a magnetic disk, optical disk, etc., and may be a fixed-type recording medium such as a hard disk device, memory, etc.

Further, a program realizing at least a partial function of the information generator 1 and information output device 2 can be distributed through a communication line (including radio communication) such as the Internet 4. Furthermore, this program may be encrypted, modulated, and compressed to be distributed through a wired line or a radio link such as the Internet 4 or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information generator, comprising:
a first interface unit to transmit a machine operating command for operating an information output device through a WebSocket connection;
a second interface unit to transmit, to the information output device, video data capable of being playbacked by the information output device;
an application executing unit to execute a web application for establishing the WebSocket connection and transmitting the machine operating command to the information output device;
a connection management unit to transmit the video data to the information output device through the second interface unit, when it is confirmed that a connection for transmitting the machine operating command through the first interface unit and a connection for transmitting the video data through the second interface unit have been established with the same information output device based on a request from the web application;
a first screen output unit to display, on a display device, a list of web applications capable of being executed by the application executing unit;
an application selector to select a specific web application from the web application list displayed by the first screen output unit;
a launcher to notify the application executing unit about a URL providing the web application selected by the application selector; and
a second screen output unit to display, on the display device, information for operating the information output device when the application executing unit accesses a URL notified by the launcher to acquire and execute the web application, and then the video data is transmitted to the information output device through the second interface unit.

2. The information generator of claim 1,
wherein the machine operating command includes an input switching command for switching whether the information output device displays the video data inputted through the second interface unit or displays video data received by a tuner in the information output device.

3. The information generator of claim 1, further comprising:
a third screen output unit to display, on the display device, information about a list of the video data, the information capable of being acquired when the application executing unit executes the web application by accessing the URL notified by the launcher.

4. The information generator of claim 1,
wherein the application executing unit comprises:
a browser processing unit to execute the web application by using a browser; and
a machine-specific processing unit to perform a machine-specific processing which is not described in the web application.

5. The information generator of claim 4,
wherein the machine-specific processing unit comprises:
a machine search processing unit to search whether the information output device is connected on a network, responding to a request from the web application; and
a connection checker to check whether the information output device having the first interface unit for transmitting the machine operating command has the second interface unit, responding to a request from the web application.

6. The information generator of claim 1,
wherein the application executing unit converts video data acquired by executing the web application into a data format capable of being playbacked by the information output device, and transmits the converted video data to the information output device through the second interface unit.

7. The information generator of claim 1, further comprising:
a touchpanel input unit to select, from the web application list displayed by the first screen output unit, a web application to be executed by the application executing unit, and to select the information for operating the information output device after the video data is transmitted to the information output device through the second interface unit.

8. The information generator of claim 1, further comprising:
a third interface unit to transmit a web application to the information output device, responding to an acquisition request of the web application by the information output device,
wherein the web application includes description of a URL (Universal Resource Locator) indicating a location of the video data to be acquired, and
when the application executing unit receives a request for playback video data from the information output device through the first interface unit, the application executing unit acquires the video data from the URL described in the web application, and transmits the video data to the information output device through the second interface unit.

9. The information generator of claim 8,
wherein the application executing unit comprises:
a channel number transmitter to transmit, to a web server, a channel number of a broadcast program currently being received by the information output device, when the channel information is transmitted from the information output device through the first interface unit;
a URL acquisition unit to acquire a URL transmitted from the web server responding to the channel number transmitted thereto; and
an application acquisition unit to acquire a web application by accessing the URL acquired by the URL acquisition unit,
the application executing unit executing the web application acquired by the application acquisition unit, and
the second interface unit transmitting, to the information output device, video data acquired when the application executing unit executes the web application.

10. An information output device, comprising:
a first interface unit to receive a machine operating command transmitted from an information generator through a WebSocket connection;
a second interface unit to receive video data transmitted from the information generator;
a video processing unit to perform video processing for displaying the video data received by the second interface unit;
a screen output unit to display the video data received through the second interface unit, when it is confirmed that a connection for transmitting the machine operating command through the first interface unit and a connection for transmitting the video data through the second interface unit are established with the same information output device, each connection being established based on a request from the web application;
a tuner to receive a broadcast program;
a machine operating command processing unit to send a command to switch whether the screen output unit displays the broadcast program received by the tuner or the video data received through the second interface unit, based on an input switching command included in the machine operating command received through the first interface unit, and to perform a machine operating process based on the machine operating command received through the first interface unit while the screen output unit displays the video data transmitted from the information generator.

11. The information output device of claim 10,
wherein the screen output unit comprises:
a first display area to display the broadcast program received by the tuner; and
a second display area to display the video data received by the second interface unit.

12. The information output device of claim 10,
wherein the second interface unit and the video processing unit are incorporated into a dongle device separated from a main housing of the information output device, and uncompressed video data processed by the video processing unit is transmitted between the dongle device and the main body.

13. A recording medium for storing a program executed by a computer,
the program comprising:
transmitting a machine operating command for operating an information output device from a first interface unit through a WebSocket connection;
transmitting, from a second interface unit to the information output device, video data capable of being playbacked by the information output device;
executing a web application for establishing the WebSocket connection and transmitting the machine operating command to the information output device;
transmitting the video data to the information output device through the second interface unit, when it is confirmed that a connection for transmitting the machine operating command through the first interface unit and a connection for transmitting the video data through the second interface unit have been established with the same information output device based on a request from the web application;
displaying, on a display device, a list of web applications capable of being executed by the step of executing a web application;
selecting a specific web application from the web application list displayed on the display device;
notifying the step of executing a web application about a URL providing the selected web application; and
displaying, on the display device, information for operating the information output device when accessing the notified URL to acquire and execute the web application, and then the video data is transmitted to the information output device through the second interface unit.

14. The recording medium of claim 13,
wherein the machine operating command includes an input switching command for switching whether the information output device displays the video data inputted through the second interface unit or displays video data received by a tuner in the information output device.

15. The recording medium of claim 13, further comprising:
displaying, on the display device, information about a list of the video data, the information capable of being acquired when the web application is executed by accessing the notified URL.

16. The recording medium of claim 13,
wherein executing the web application comprises:
executing the web application by using a browser; and
performing a machine-specific processing which is not described in the web application.

17. The recording medium of claim 16,
wherein performing the machine-specific processing comprises:
searching whether the information output device is connected on a network, responding to a request from the web application; and
checking whether the information output device having the first interface unit for transmitting the machine operating command has the second interface unit, responding to a request from the web application.

18. The recording medium of claim 13,
wherein executing the web application converts video data acquired by executing the web application into a data format capable of being playbacked by the information output device, and transmits the converted video data to the information output device through the second interface unit.

19. The recording medium of claim 13, further comprising:
selecting, from the web application list displayed by the display device, a web application to be executed, and to select the information for operating the information output device after the video data is transmitted to the information output device through the second interface unit.

20. The recording medium of claim 13, further comprising:
a third interface unit to transmit a web application to the information output device, responding to an acquisition request of the web application by the information output device,
wherein the web application includes description of a URL (Universal Resource Locator) indicating an acquisition destination of the video data, and
when executing the web application receives a request for playbacking video data from the information output device through the first interface unit, the video data is acquired from the URL described in the web application, and the video data is transmitted to the information output device through the second interface unit.
